(19) United States
(12) Patent Application Publication
(10) Pub. No.: US 2005/0186413 A1
(43) Pub. Date: Aug. 25, 2005

(54) Vehicle body panel

(75) Inventors: Tobias Niesner, Wolfsburg (DE); Andre Schaper, Vechelde (DE); Hans Hermann Goetzke, Vechelde (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/046,959

(22) Filed: Jan. 31, 2005

(30) Foreign Application Priority Data
Feb. 23, 2004 (DE) 10 2004 008 718.0

(51) Int. Cl. B32B 9/00

(52) U.S. Cl. 428/318.4; 428/319.3; 428/319.7

(57) ABSTRACT

A vehicle body panel includes a plastic sheet that forms a portion of an outer skin of a vehicle. Prior to deep-drawing the vehicle body panel, a rear side of the plastic sheet is flame-treated. In one example, the rear side is silica-coated during flame treating. Subsequently, the rear side of the plastic sheet is provided with a foam backing or an injection-molded backing.

### RELATED APPLICATIONS

This application claims priority to German Patent Application No. 10 2004 008 718.0, which was filed on Feb. 23, 2004.

### TECHNICAL FIELD

The present invention relates to a vehicle body panel, and a method of manufacturing the vehicle body panel.

### BACKGROUND OF THE INVENTION

Vehicle body panels are connected to a vehicle frame to define an outer skin of a vehicle in a final assembled condition. One example of a vehicle body panel is a roof module that defines almost an entire vehicle roof. The roof module is a composite structure that is preferably attached on a roof frame by bonding. Other vehicle body panels include e.g. flaps, doors, fenders, and bumpers.

Vehicle body panels may be produced to have an excellent surface quality by using a thin, deep-drawn plastic sheet that is dyed throughout, and which is provided with a foam backing on a rear side. For a liquid plastic material to adhere to the plastic sheet, the plastic sheet is flame-treated immediately before attaching the foam backing. During the flame-treatment, a gas flame is swept over the rear side to “activate” the plastic sheet. During activation, molecular chains at a surface of the plastic sheet are broken up. Oxygen and hydroxyl groups will attach to the broken-up molecular chains. At the same time, surfaces on the plastic sheet are cleaned and a micro-roughening is performed, which also provides for a better connection between the plastic sheet and a polyurethane (PU) material.

In addition, a previously non-polar surface of the plastic sheet is polarized to a certain degree, and wettability is increased. In such a flame-treatment, it is known to admix a vaporizable silicon compound to a combustible gas/air mixture, which is referred to as a “silica-coating technique.”

Flame-treatment, or silica-coating where appropriate, is a method step that involves high reject rates. These high reject rates are due to high degrees of extension that occur in the deep-drawing process, and the associated stretching of the plastic sheet, during the flame-treatment or the silica-coating process, in which the plastic sheet tends to be very easily damaged. Moreover, the flame-treatment is typically a manual process where desired low reject rates are achievable only with very experienced staff.

It is the object of the invention to improve a method of manufacturing a vehicle body panel that produces a higher process reliability, in addition to overcoming the other deficiencies mentioned above.

### SUMMARY OF THE INVENTION

A method for manufacturing a vehicle body panel includes flame-treating a rear side of a plastic sheet that defines at least a portion of an outer skin of a vehicle, plastically reshaping the plastic sheet, and providing the rear side of the plastic sheet with a foam backing or an injection-molded backing.

In the method according to the invention, the plastic sheet is flame-treated before it is plastically reshaped, that is, usually before a deep-drawing process. In this state, the plastic sheet is more even than after the reshaping process. Further, the plastic sheet is preferably flat and of a constant material thickness (approx. 0.5 to 1.5 mm) so that no portions with high degrees of extension are present, and the flame-treatment can be performed more easily and more uniformly. Surprisingly, it is found that activation of the plastic sheet, as achieved by the flame-treatment, is not reversed during reshaping. The method according to the invention renders it possible to reduce reject rates; furthermore, the use of a very simple automated flame-treatment step provides easy documentability of this method step, by which a manufacturer is able to provide written evidence that all method steps have been fulfilled in producing the product.

One example embodiment provides for a silica-coating of the rear side of the plastic sheet, which is attained by admixing a vaporizable silicon compound, in particular silanes or an organic silicon compound such as organosilanes. An extremely thin layer of a silicon compound, particularly in a form of a silicon oxide SiOx (were x is about 2), is deposited on the rear side of the plastic sheet. This thin layer, which is only a few nanometers thick, has a certain roughness and increases adhesive surface tension. It also acts as a diffusion barrier layer.

In one example, the rear side of the plastic sheet has the foam backing across an entire surface area. In this example, the plastic sheet is also provided with the layer of the silicon compound across the entire surface area. A liquid PU material is preferably applied to provide the foam backing.

The invention also relates to a vehicle body panel having a deep-drawn plastic sheet provided with a foam backing or an injection-molded backing of a PU material wherein the vehicle body panel defines part of the outer skin of the vehicle. Applied on the rear side of the plastic sheet is a thin layer of a silicon compound, in particular SiOx. The PU material adjoins this thin layer.

These and other features of the present invention can be best understood from the following specification and drawings, the following of which is a brief description.

### BRIEF DESCRIPTION OF THE DRAWINGS

FIG. 1 is a perspective view of a roof module, manufactured by means of the method according to the invention, in the installed condition.

FIG. 2 shows a step of the method according to the invention for manufacturing the roof module of FIG. 1.

FIG. 3 shows a successive step to the step shown in FIG. 2.

FIG. 4 shows a successive step to the step shown in FIG. 3.

### DETAILED DESCRIPTION OF THE PREFERRED EMBODIMENT

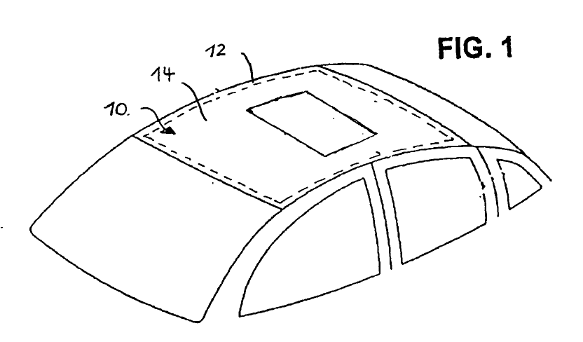

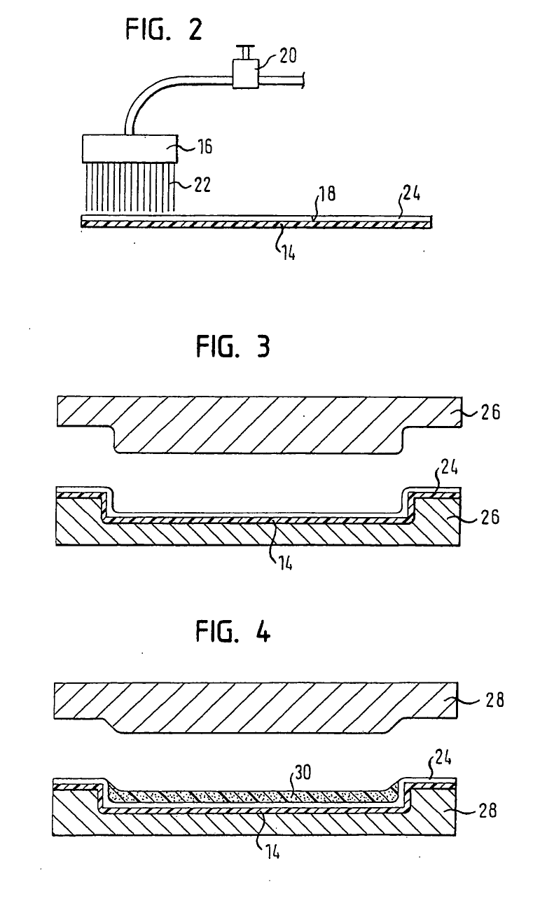

FIG. 1 illustrates a vehicle body panel in the form of a roof module 10. The roof module 10 is a plastic composite structure that is bonded onto a roof frame 12 to define an outer skin of a vehicle in the area of a vehicle roof. The outside of the roof module 10 consists of a thin plastic sheet 14 that is dyed throughout, and which is provided with a foam backing on a rear side 18 (FIG. 2).

The method of manufacturing the roof module 10 will now be explained with reference to FIGS. 2 through 4.

Prior to the plastic sheet 14 being plastically reshaped, the plastic sheet 14, which is substantially flat, is first flame-treated. To this end, a burner 16 is moved along the rear side 18 of the plastic sheet 14 and produces a flame that is denoted by reference numeral 22. The burner 16 utilizes a vaporizable silicon compound, in particular silanes or a vaporizable organo-silicon compound, which is admixed to a combustible gas/air mixture in a metering valve 20.

In the flame-treatment, a silicon compound is deposited on the rear side 18 in the form of a layer 24 of SiOx, with x being approximately 2. The layer 24 has a thickness of a few nanometers. In FIG. 2 this layer 24 is shown extremely exaggerated in a vertical direction.

In the next method step, the plastic sheet 14, which has been activated by the flame-treatment, is placed in a deep-drawing die 26, where the plastic sheet 14 is plastically reshaped. FIG. 3 shows the deep-drawing die 26 in an opened condition after the reshaping process.

Finally, after deep-drawing, the plastic sheet 14 is placed in a foaming die 28 where a liquid PU material 30 is applied onto a rear side of the layer 24, which covers an entire rear side 18 of the plastic sheet 14. Then the foaming die 28 is closed and the PU material 30 expands. This process, often referred to as “back-foaming,” provides a foam backing directly to the layer 24.

The method steps shown in FIGS. 3 and 4 may, of course, also be carried out in a combined die.

The finished body panel shown in FIG. 4 is eventually removed from the foaming die 28 and edge-trimmed.

In addition to applying liquid PU material 30 onto the rear side 18 of the plastic sheet 14, glass fiber sections are preferably incorporated into the plastic layer during application in a process referred to as a LFI (long fiber injection) process.

In place of the process of providing a foam backing as shown in FIG. 4, the plastic sheet 14 may be provided with an injection-molded backing using an appropriately designed die.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of manufacturing a vehicle body panel comprising:
(a) flame-treating a rear side of a plastic sheet that defines at least a portion of an outer skin of a vehicle,
(b) plastically reshaping the plastic sheet; and
(c) attaching a backing to the rear side of the plastic sheet.

2. The method according to claim 1, including admixing a vaporizable silicon compound to a combustible gas/air mixture that burns during flame-treating, and depositing the vaporizable silicon compound as a layer on the rear side of the plastic sheet.

3. The method according to claim 2, wherein the vaporizable silicon compound is a silicon oxide.

4. The method according to claim 2, including applying the layer onto the rear side of the plastic sheet over an entire surface area of the plastic sheet.

5. The method according to claim 1, wherein step (b) includes deep-drawing the plastic sheet.

6. The method according to claim 1, wherein step (c) includes attaching a foam backing to the plastic sheet using liquid poly-urethane material.

7. The method according to claim 1, wherein in step (a) the plastic sheet is flat.

8. The method according to claim 1, wherein step (c) includes back-foaming a foam backing to the plastic sheet.

9. The method according to claim 1, wherein step (c) includes injection-molding the backing to the plastic sheet.

10. The method according to claim 1, wherein step (b) is performed subsequent to step (a).

11. A vehicle body panel comprising:
a deep-drawn plastic sheet having a backing and defining at least a portion of an outer skin of a vehicle, the deep-drawn plastic sheet having a thin layer of a silicon compound positioned between the deep-drawn plastic sheet and the backing.

12. The vehicle body panel according to claim 11, wherein the backing comprises a foam backing of polyurethane material.

13. The vehicle body panel according to claim 11, wherein the thin layer of the silicon compound includes silicon oxide.

14. The vehicle body panel according to claim 11, wherein the backing comprises an injection-molded backing.

15. A vehicle body panel comprising:
a plastic sheet having an inner side and an outer side facing opposite from the inner side, wherein the outer side forms at least a portion of an outer skin of a vehicle;
an intermediate layer of silicon material attached to the inner side of the plastic sheet; and
a backing layer attached to the intermediate layer of silicon material.

16. The vehicle body panel according to claim 15 wherein the intermediate layer of silicon material comprises silicon oxide.

17. The vehicle body panel according to claim 16 wherein the backing layer comprises a foam material.

18. The vehicle body panel according to claim 16 wherein the inner side of the plastic sheet includes a flame treated surface.

19. The vehicle body panel according to claim 18 wherein the plastic sheet is plastically re-shaped to receive the backing layer.
